(19) United States
(12) Patent Application Publication
(10) Pub. No.: US 2004/0242099 A1
(43) Pub. Date: Dec. 2, 2004

(54) Leather-like sheet and production method thereof

(75) Inventors: Shinichi Yoshimoto, Okayama (JP); Tetsuya Ashida, Okayama (JP); Hisao Yoneda, Okayama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kuraray Co., Ltd., Kurashiki-shi (JP)

(21) Appl. No.: 10/854,176

(22) Filed: May 27, 2004

(30) Foreign Application Priority Data
May 29, 2003 (JP) 2003-152550

(51) Int. Cl. B32B 3/00

(52) U.S. Cl. 442/59; 428/904

(57) ABSTRACT

The leather-like sheet of the present invention comprises an entangled nonwoven fabric which is made of a mixture comprising fibers of an elastic polymer and microfine fibers of a inelastic polymer having an average single fiber fineness of 0.1 dtex or less. The fibers of the elastic polymer are partially porous and are partially fuse-bonded to each other. With such fibrous structure, the leather-like sheet substantially sustains repeated extensional deformations without causing permanent change of its original structure and configuration. The leather-like sheet are excellent in elastic stretchability, soft and dense feel and drapeability, and is successfully made into a napped leather-like sheet excellent in appearance, feel, elastic stretchability and drapeability.

### BACKGROUND OF THE INVENTION

1. Field of the Invention

The present invention relates to leather-like sheets having an excellent elastic stretchability, more specifically, relates to leather-like sheets which substantially sustain repeated extension al deformations without causing permanent change of their original structure and configuration, are excellent in elastic stretchability, shape-sustaining properties, shape stability and shape recovery, and have a soft and dense feel, particularly relates to napped leather-like sheets having a good appearance and an excellent feel, elastic stretchability and drapeability. The present invention further relates to a production method of the leather-like sheets.

2. Description of the Prior Art

Napped sheets produced by napping at least one surface of fibrous textiles such as woven fabrics, knit fabrics and nonwoven fabrics or at least one surface of fibrous substrates having foamed structure of elastic polymer therein have appearance, texture, feel and hand, which are expressed by the length, density and other properties of raised fibers, well simulating those natures of natural suede or nubuck leathers. Therefore, such napped sheets are recently mass-produced as napped sheets with suede- or nubuck-finish. Particularly, known napped artificial leathers with suede- or nubuck-finish, which are produced by raising a nap of microfine fibers on the surface of a fibrous substrate comprising an entangled nonwoven fabric of microfine fibers and an elastic polymer impregnated thereinto, are known as textile materials being comparable to natural leathers in their structures and having qualities equal to or higher than those of natural leathers because of their excellent properties such as elegant napped surface, soft touch, dense feel, excellent drapeability irrespective of its light weight, and no ravel at cutting surface which is usually found in woven or knit fabric.

There has been a continuous demand for further improving the quality of napped leather-like sheets to provide high-quality products which are satisfactory in every quality relating to aesthetic sense, feel, hand and clothing comfort such as suede appearance, nubuck appearance, soft touch, excellent feel and excellent drapeability.

For example, to produce a stretchable napped leather-like sheet with excellent feel, Japanese Patent Publication No. 1-41742 proposes a stretchable entangled nonwoven fabric which is produced by shrinking an entangled nonwoven fabric comprising elastic polymer fibers (elastic fibers) and inelastic polymer fibers (inelastic fibers) in 10 to 80% by area ratio. The proposed artificial leather made of the elastic fibers and inelastic fibers is excellent in drapeability because of flexibility attributable to the elastic fibers all remaining in free fibrous conditions, but poor in passing properties through the process for napping by buffing, etc. because of a poor effect for binding inelastic fibers, rough in napped appearance and far from suede or nubuck appearance.

Japanese Patent Publication No. 3-16427 proposes an artificial leather with good mechanical properties which is made of composite fibers capable of forming two or more kinds of elastic fibers of different melting points and fibers capable of forming microfine inelastic fibers. However, the binder effect is still insufficient, although a small binder effect is obtained by the melting of low-melting elastic fibers constituting the artificial leather. In addition, an artificial leather excellent in suede-look is not produced by the proposed method.

Japanese Patent Publication No. 5-65627 proposes an artificial leather with a good appearance which is produced by impregnating polyurethane into a nonwoven fabric made only of sea-island fibers capable of forming inelastic microfine fibers, removing the sea component by solvent extraction to form the inelastic microfine fibers, and then dyeing. However, since the nonwoven fabric does not include elastic fibers, the proposed artificial leather loses its original structure after repeated extensional deformations. In addition, the proposed artificial leather fails to have excellent soft hand, feel and drapeability because the polyurethane resin impregnated into the nonwoven fabric forms a foamed sheet structure.

### SUMMARY OF THE INVENTION

By the methods proposed in Japanese Patent Publication Nos. 1-41742 and 3-16427, a napped surface of raised fibers with a good appearance is not obtained, although stretchability is obtained. Although a good appearance is obtained by the method proposed in Japanese Patent Publication No. 5-65627, it is difficult to obtain excellent stretchability, feel and drapeability.

An object of the present invention is to provide a leather-like sheet comprising an entangled nonwoven fabric of intermingled fibers of an elastic polymer and microfine fibers of an inelastic polymer, which is excellent in elastic stretchability, feel and drapeability, a production method thereof, and a napped leather-like sheet excellent in appearance.

As a result of extensive research, the inventors have found that the above object is achieved by an entangled nonwoven fabric made of partially porous elastic fibers and inelastic microfine fibers, in which the elastic fibers are allowed to partially fuse-bond to each other. The present invention has been accomplished on the basis of this finding.

Thus, the present invention provides a leather-like sheet comprising an entangled nonwoven fabric which is made of a mixture comprising fibers of an elastic polymer (elastic fibers) and microfine fibers of an inelastic polymer (inelastic microfine fibers) having an average single fiber fineness of 0.1 dtex or less, the fibers of the elastic polymer being partially porous and being partially fuse-bonded to each other.

It is preferred for the elastic fibers to be partially fuse-bonded to each other to form a partial network structure, and to be partially fuse-bonded to the inelastic microfine fibers.

The present invention further provides a napped leather-like sheet comprising the above leather-like sheet, at least one surface thereof being made into a napped surface mainly comprising raised inelastic microfine fibers.

The present invention still further provides a method of producing a leather-like sheet, sequentially comprising:

a step I of producing an entangled nonwoven fabric comprising fibers A capable of forming fibers of an elastic polymer and fibers B capable of forming microfine fibers of an inelastic polymer having an average single fiber fineness of 0.1 dtex or less, a part of a component for forming the fibers of an elastic polymer being exposed at least to a part of surface of the fibers A;

a step II of impregnating a liquid containing at least a good solvent for the elastic polymer into the nonwoven fabric, thereby partially dissolving the elastic polymer;

a step III of impregnating a liquid containing at least a poor solvent for the elastic polymer into the nonwoven fabric, thereby making the partially dissolved elastic polymer into partially porous; and

a step IV of converting the fibers A and the fibers B respectively into the fibers of the elastic polymer and the microfine fibers of the inelastic polymer having an average single fiber fineness of 0.1 dtex or less.

The leather-like sheet of the present invention substantially sustains repeated extensional deformations without causing permanent change of its original structure and configuration, because the elastic fibers are partially porous and partially fuse-bonded to each other. The leather-like sheet are excellent in elastic stretchability, shape-sustaining properties, shape stability and shape recovery, and has soft and dense feel. The leather-like sheet is successfully made into a napped leather-like sheet excellent in appearance, feel, elastic stretchability and drapeability.

### BRIEF DESCRIPTION OF THE DRAWINGS

FIG. 1 is an electron micrograph showing the cross section of a leather-like sheet of the present invention after removing only inelastic microfine fibers;

FIG. 2 is an electron micrograph showing the surface of a leather-like sheet of the present invention after removing only inelastic microfine fibers;

FIG. 3 is an electron micrograph showing the cross section of a conventional leather-like sheet comprising a nonwoven fabric made only of inelastic microfine fibers and an elastic polymer impregnated thereinto, after removing only inelastic microfine fibers; and

FIG. 4 is an electron micrograph showing the surface of a conventional leather-like sheet comprising a nonwoven fabric made only of inelastic microfine fibers and an elastic polymer impregnated thereinto, after removing only inelastic microfine fibers.

### DETAILED DESCRIPTION OF THE INVENTION

The present invention will be described below in detail.

The fibers of the elastic polymer (elastic fibers) are formed by melt-spinning only the elastic polymer into fibers, by splitting multi-component fibers which is produced by melt-spinning a combination of the elastic polymer and at least one spinnable polymer different from the elastic polymer in their chemical and physical properties, or by removing at least one polymer component from the multi-component fibers by extraction. The multi-component fibers have an elastic fiber-forming component at least partially on their surface and are capable of generating the elastic fibers by splitting or extraction (hereinafter referred to as “fibers A”). The fibers A are not specifically limited in their structure as long as they are composite fibers having a structure in which the elastic polymer is exposed to at least a part of their surface, and preferably sea-island fibers and splittable fibers, with sea-island fibers being more preferred and sea-island mix-spun fibers being still more preferred because the elastic polymer as the island component is allowed to be randomly present on at least a part of the surface. The areal proportion of the surface of the fibers A occupied by the elastic polymer is preferably 0.1 to 95%, more preferably 1 to 70%. When 0.1% or more, the elastic fibers are easily made into partially porous to ensure the partial fuse-bonding of the elastic fibers. When 95% or less, the deterioration of the process passing properties such as card passing properties attributable to the properties of elastic polymer can be avoided.

Examples of the elastic polymers include polyurethanes which are produced by the reaction of at least one polyol selected from polymer polyols having a number average molecular weight of 500 to 3500 such as polyester polyol, polyether polyol, polyester ether polyol, polylactone polyol and polycarbonate polyol, an aromatic, alicyclic or aliphatic polyisocyanate such as 4,4′-diphenylmethane diisocyanate, tolylene diisocyanate, isophorone diisocyanate, dicyclohexylmethane 4,4′-diisocyanate and hexamethylene diisocyanate, and a chain extender having two active hydrogen atoms such as 1,4-butanediol and ethylenediamine; polyester elastomers such as polyester elastomer and polyether ester elastomer; polyamide elastomers such as polyether ester amide elastomer and polyester amide elastomer; conjugated diene polymers such as polyisoprene and polybutadiene; block copolymers having a backbone comprising a block of conjugated diene copolymer such as polyisoprene and polybutadiene; and melt-spinnable elastomers showing rubber elastic behavior. Of the above, polyurethanes are most preferred because of their good softness, low resilience, high abrasion resistance, easiness of fuse-bonding to inelastic microfine fibers, high heat resistance, excellent durability, etc.

The elastic polymer may contain a pigment such as carbon black and an additive such as a heat stability improver for resin in an amount not adversely affecting the effect of the present invention.

The sea component polymer (polymer to be removed by extraction or decomposition) of the fibers A (multi-component fibers) is required to be different from the island component polymer in the solubility to solvent and the decomposability by decomposer. For example, a polymer having a solubility and decomposability higher than those of the island component polymer, having a low compatibility or affinity to the island component polymer, and having a melt viscosity or a surface tension smaller than those of the island component polymer is preferably used as the sea component polymer. Examples thereof may be melt-spinnable polymers including easy soluble polymers such as polyethylene, polystyrene, modified polystyrene and ethylene-propylene copolymer; and easy decomposable polymers such as poly(ethylene terephthalate) modified or copolymerized with sodium sulfoisophthalate or polyethylene glycol.

The microfine fibers of the inelastic polymer (inelastic microfine fibers) are formed by splitting multi-component fibers comprising the inelastic polymer and at least one spinnable polymer different from the inelastic polymer in their chemical and physical properties, or by removing at least one polymer component from the multi-component fibers by extraction. The multi-component fibers are required to form inelastic microfine fibers having an average single fiber fineness of 0.1 dtex or less by splitting or extraction (hereinafter referred to as “fibers B”). The fibers B are not specifically limited in their structure as long as they are composite fibers capable of generating inelastic microfine fibers having an average single fiber fineness of 0.1 dtex or less, and preferably sea-island fibers or splittable fibers. The content of the inelastic polymer in fiber B is preferably 10 to 90% by mass, more preferably 30 to 70% by mass.

Examples of the inelastic polymers include melt-spinnable polyamides such as nylon-6, nylon-66, nylon-10, nylon-11, nylon-12 and their copolymers; melt-spinnable polyesters such as poly(ethylene terephthalate), poly(trimethylene terephthalate), poly(butylene terephthalate) and cation-dyeable modified poly(ethylene terephthalate); and melt-spinnable polyolefins such as polypropylene and its copolymers. One or two kinds or more of these polymers may be used separately or in mixture.

When the fibers B are sea-island fibers, it is necessary to allow the inelastic polymer constituting the island component to convert into separated microfine fibers without undue bonding of the resultant inelastic fibers. When the fibers A and the fibers B are both sea-island fibers, the inelastic polymer is preferably selected at least so as not to allow the resulting inelastic microfine fibers to bond together by the solvent treatment for removing the sea component by extraction, etc. Specifically, polymers having a 10% by mass or less of degree of swelling by solvent when subjected to the treatment for removing the sea component are preferably selected.

The inelastic polymer may contain a pigment such as carbon black and an additive such as a heat stability improver for resin in an amount not adversely affecting the effect of the present invention.

The polymer for the sea component polymer of the fibers A as mentioned above is equally usable as the sea component polymer for the fibers B. The sea components of the fibers A and the fibers B may be different polymers, but preferably the same in view of efficiently removing the sea components.

In view of melt-spinning stability, the inelastic polymer and the sea component polymers of the fibers A and the fibers B are preferably selected so as to have melting points close to the melt-spinnable temperature of the elastic polymer. For example, the melting points of the inelastic polymer and the sea component polymers are preferably 230° C. or less when the elastic polymer is polyurethane, and preferably 260° C. or less when the elastic polymer is polyester elastomer or polyamide elastomer.

The fibers A and the fibers B may be produced by known methods and formed into a nonwoven fabric by known methods. For example, the fibers A and the fibers B are respectively drawn, crimpled, cut and provided with oil. Then, the fibers A and the fibers B are mixed in a desired ratio, carded and made into a web through a webber. The mixing ratio of the fibers A and the fibers B are selected so that the ratio of elastic polymer:inelastic polymer is preferably 20:80 to 80:20 by mass, because the elastic stretchability and feel of the leather-like sheet are excellent and a good napping of the napped leather-like sheet is obtained. When the proportion of the elastic polymer is 20% by mass or more, the elastic stretchability of the resultant leather-like sheet is improved, and the effect of napping treatment is easily obtained and a rubber-like insufficient napping is avoided when 80% by weight or less.

After laminated to a desired weight and thickness, the laminated webs are made into a nonwoven fabric by a known entangling method such as needle-punch entanglement and hydroentanglement. It is preferred to shrink the entangled nonwoven fabric by heat-treating at 50 to 150° C. in air or at 50 to 95° C. in hot water, because an excellent elastic stretchability is obtained. The shrinkage percentage is determined according to the kinds of fibers, the mass ratio of the elastic polymer and the inelastic polymer, the spinning and drawing conditions of the fibers A and the fibers B, etc. The shrinkage percentage of the entangled nonwoven fabric is preferably 5 to 50% by area ratio because the resultant leather-like sheet has good appearance and elastic stretchability and substantially sustains repeated extensional deformations without causing change of the original structure or configuration.

The entangled nonwoven fabric may be, if necessary, provisionally fixed by a resin removable by dissolution such as a water-soluble sizing agent including polyvinyl alcohol, etc. The surface of the entangled nonwoven fabric may be heat-pressed by a known method to smooth the surface and provide the napped leather-like sheet with an excellent writing effect.

The thickness of the entangled nonwoven fabric is suitably selected according to the use of the leather-like sheet, etc., and not strictly limited. The thickness of a single-layered nonwoven fabric is preferably about 0.2 to 10 mm, more preferably about 0.4 to 5 mm. The density is preferably 0.20 to 0.65 g/cm³, more preferably 0.25 to 0.55 g/cm³. If 0.20 g/cm³ or more, insufficient napping of fibers and deterioration of mechanical properties are avoided. If 0.65 g/cm³ or less, the feel of resultant leather-like sheet is prevented from becoming hard.

Then, the entangled nonwoven fabric is impregnated with a treating solution A containing at least a solvent for the elastic polymer to partially dissolve the elastic polymer on the surface or end of the fibers A (elastic fiber-forming component). Thereafter, impregnated with a treating solution B containing at least a non-solvent for the elastic polymer to coagulate the partially dissolved elastic polymer into porous form simultaneously with allowing the fibers A to partially fuse-bond together via the elastic polymer.

Examples of the solvents for the elastic polymer, when the elastic polymer is polyurethane, include good solvents for polyurethane such as N,N-dimethylformamide (DMF), dioxane and alcohols, with DMF being preferred. The treating solution A may be a mixture of a good solvent and a poor solvent for the elastic polymer and may contain the elastic polymer in a low concentration, preferably 1 to 30% by mass, more preferably 1 to 10% by mass in terms of solid content. If 30% by mass or less, although depending on the impregnated amount, the reduction of the drapeability and elastic stretchability of the resultant leather-like sheet is avoided because the elastic fibers and/or the inelastic fibers are prevented from being fixed by the elastic polymer to lose the free movement.

Preferred examples of the elastic polymers which may be contained in the treating solution A include polyurethanes produced by the reaction in a desired ratio of at least one polymer diols having a number average molecular weight of 500 to 3500 selected form polyester diol, polyether diol, polyether ester diol, polylactone polyol and polycarbonate diol; at lease one organic polyisocyanate selected from aromatic, alicyclic and aliphatic polyisocyanates such as 4,4′-diphenylmethane diisocyanate, isophorone diisocyanate and hexamethylene diisocyanate; and at least one low-molecular compound having two or more active hydrogen atoms such as ethylene glycol and ethylenediamine. If desired, a polymer such as synthetic rubber and polyester elastomer may be mixed with polyurethane. The treating solution A containing the elastic polymer may be added with an additive such as colorant, coagulation regulator and antioxidant.

The mass ratio of the elastic polymer in the impregnated treating solution A and the total amount of the elastic polymer in the entangled nonwoven fabric is preferably 0.2/100 to 30/100, more preferably 0.5/100 to 10/100. If the mass ratio is 30% by mass or less, the deterioration of the elastic stretchability, feel and drapeability of the leather-like sheet is prevented.

As the non-solvent for the elastic polymer, a poor solvent for polyurethane such as water is used when the elastic polymer is polyurethane. By impregnating the treating solution B after impregnating the treating solution A into the entangled nonwoven fabric, the partially dissolved elastic polymer is coagulated to a porous structure. The dissolved elastic polymers at different positions are partially united during the coagulation to allow the fibers A to partially fuse-bond together. It is preferred to control the number of fuse-bonded portions of the fibers A to form a partial network structure by increasing the area ratio of the elastic fiber-forming component exposed to the surface of the fibers A by a known spinning method, by increasing the impregnated amount of the treating solution A, or by increasing the content of the good solvent for the elastic polymer in the treating solution A.

The porous structure referred to herein means a fine spongy structure formed by wet-coagulating the elastic polymer. If the elastic fibers generated from the fibers A are partially porous, the feel and drapeability of the resultant leather-like sheet are made excellent.

The treating solution A is impregnated by a known method such as immersion method, gravure method and spraying method, with the immersion method being preferred because the treating solution A is sufficiently impregnated into the inside of the entangled nonwoven fabric and easily adheres to the surface of the fibers A in a sufficient amount.

By impregnating the treating solution A into the entangled nonwoven fabric, the elastic fiber-forming component exposed to the surface and end of the fibers A is partially dissolved. To avoid excessive dissolution, the treatment with the treating solution A is preferably performed at 10 to 60°C., for 30 s to 4 min. Immediately thereafter or after removing the excess of the treating solution A, the treating solution B is impregnated into the entangled nonwoven fabric. The impregnation of the treating solution B is done in any manner as described with respect to the impregnation of the treating solution A. The treatment with the treating solution B is preferably performed at 25 to 50° C. for 10 to 30 min. The impregnated amount of the treating solution B is preferably 100 parts by mass or more per 100 parts by mass of the total elastic polymer in the entangled nonwoven fabric in view of stable coagulation of the elastic fiber-forming component.

The entangled nonwoven fabric treated with the treating solution A and the treating solution B in a manner described above is dried, and then, the elastic fibers and inelastic fibers are generated from the fibers A and the fibers B. The fibers A and the fibers B are, when made of sea-island fibers, preferably treated with a liquid capable of dissolving or decomposing the sea component polymer by immersion, etc. Toluene is used when the sea component is polyethylene or polystyrene, and aqueous solution of sodium hydroxide is used when the sea component is easy alkali-decomposable polyester. The amount of the liquid for dissolution or decomposition is preferably 100 parts by mass or more per 100 parts by mass of the total amount of the sea component polymer. The treating temperature is preferably 5 to 50° C., and the treating time is preferably 5 to 40 min.

By such a treatment, the sea component is removed from the fibers A and the fibers B. The fibers A are converted into elastic fibers which are partially porous. The generated elastic fibers are partially fuse-bonded to each other to form the partial network structure. The fibers B are converted into inelastic microfine fibers or bundles thereof. It is preferred to allow the elastic fibers and the inelastic microfine fibers to partially fuse-bond by reducing the proportion of the sea component of the fibers A and the fibers B by a know spinning technique, or by exposing the island component to the surface. The average single fiber fineness of the elastic fibers generated from the fibers A is preferably 0.01 to 2 dtex, more preferably 0.01 to 0.5 dtex. The average single fiber fineness of the inelastic microfine fibers generated from the fibers B is 0.1 dtex or less, preferably 0.001 to 0.05 dtex. If exceeding 0.1 dtex, the appearance of napped surface becomes rough and a high quality comparable to natural leathers is not obtained in touch, feel, etc.

In the present invention, the words “the elastic fibers are partially porous” mean that 10 to 100% of the surface of the elastic fibers are porous when observing the surface or sliced surface along the surface of the leather-like sheet under a scanning electron microscope after removing the inelastic microfine fibers by extraction or decomposition.

The words “the elastic fibers are fuse-bonded” mean that the elastic fibers are melted and partially bonded together. The degree of fuse-bonding of the elastic fibers is evaluated by the density of fuse-bonded portions, which is preferably 1 to 10 portions/2 mm², more preferably 2 to 8 portions/2mm² when observed under a scanning electron microscope in the same manner as described above. Within the above range, the resultant leather-like sheet substantially sustains repeated extensional deformations without causing change in the structure and configuration and has an excellent elastic stretchability.

The “network structure” referred to herein means a structure in which one elastic fiber is two- and three-dimensionally fuse-bonded with one or more other elastic fibers in branched form, and the one or more other elastic fibers are further fuse-bonded to or brought into contact with other fibers. The degree of the network formation is evaluated by the frequency of its occurrence, which is preferably 1 to 50 occurrences/5 mm², more preferably 2 to 40 occurrences/5 mm². Within the above range, the resultant leather-like sheet substantially sustains repeated extensional deformations without causing change in the structure and configuration and has an excellent elastic stretchability.

With reference to the attached drawings, the partially porous state of the elastic fibers, the partial fuse-bonding of the elastic fibers, and the partial network structure will be described below.

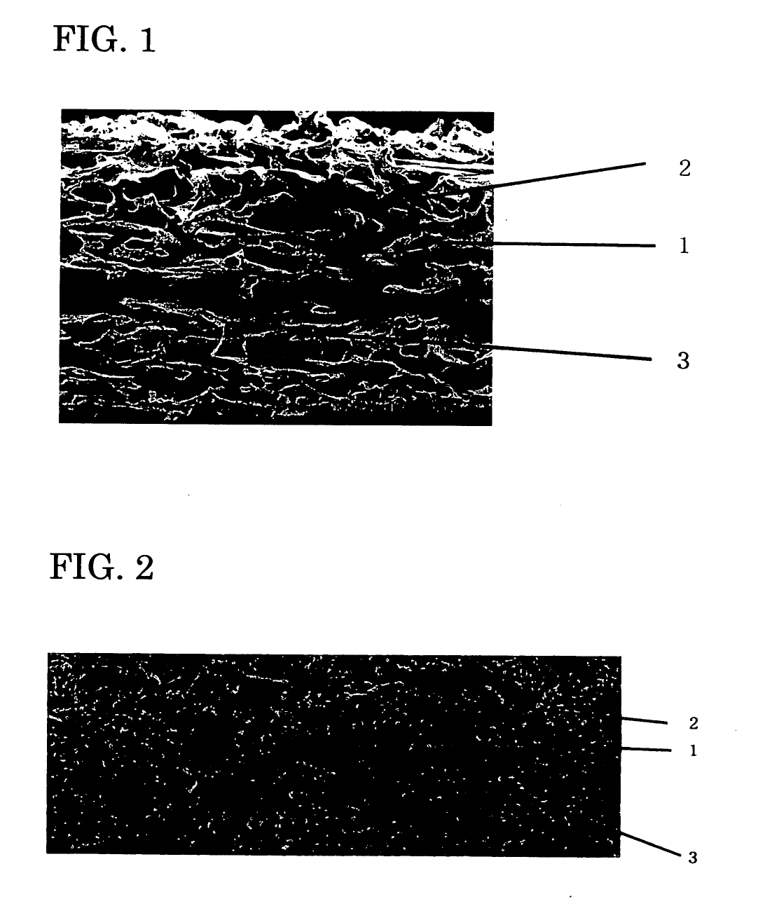

FIG. 1 is an electron micrograph showing the cross section of a leather-like sheet of the present invention after removing only inelastic microfine fibers. The reference numeral 2 is the elastic fiber, the reference numeral 1 shows a partially porous structure of the elastic fiber, and the reference numeral 3 shows a fuse-bonded portion of the elastic fiber. FIG. 2 is an electron micrograph showing the surface of a leather-like sheet of the present invention after removing only inelastic microfine fibers. In FIG. 1 and FIG. 2, like reference numerals indicate like parts. From FIGS. 1 and 2, it can be found that, in the leather-like sheet of the present invention, the elastic fibers constitute the entangled nonwoven fabric structure, the elastic fibers are partially porous, the elastic fibers are partially fuse-bonded together, and the partial fuse-bonding forms the partial network structure.

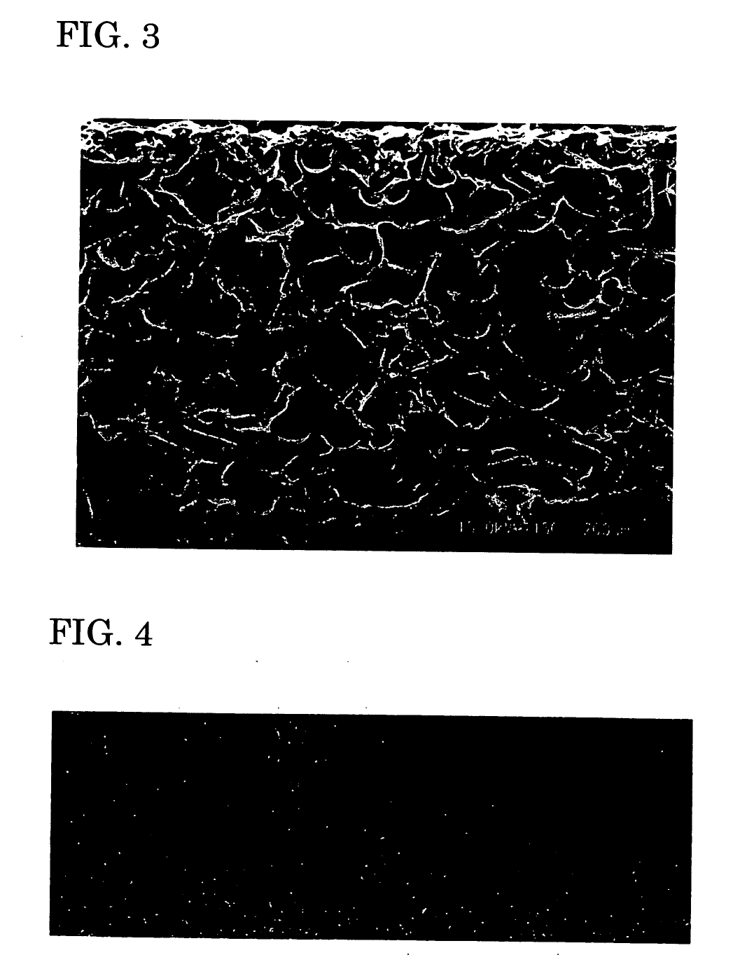

FIG. 3 is an electron micrograph showing the cross section of a conventional leather-like sheet, which comprises a nonwoven fabric made only of inelastic microfine fibers and an elastic polymer impregnated thereinto, after removing only inelastic microfine fibers. FIG. 4 is an electron micrograph showing the surface of a conventional leather-like sheet, which comprises a nonwoven fabric made only of inelastic microfine fibers and an elastic polymer impregnated thereinto, after removing only inelastic microfine fibers. As seen from FIGS. 3 and 4, unlike the leather-like sheet of the present invention, the conventional leather-like sheet contains the elastic polymer as a sheet which is entirely made into porous.

The leather-like sheet obtained by subjecting the entangled nonwoven fabric to the treatment for forming microfine fibers may be, if desired, sliced along the major surface thereof into two or more pieces. The napped leather-like sheet is produced by napping at least one surface of the leather-like sheet into a napped surface mainly comprising microfine fibers. The napped surface is formed by a known method such as buffing using a sandpaper. Before the napping treatment, by coating a solvent or solution such as a good solvent for the elastic polymer and a combination of the good solvent and a poor solvent or a known binder resin on the surface of the leather-like sheet by a gravure method, a spray method, a coater method, etc., or by heat-pressing to fix the elastic fibers present on the surface of the leather-like sheet, the formation of the napping surface mainly comprising the inelastic microfine fibers can be facilitated . With such a treatment before the napping treatment, the writing effect and the surface touch are made more excellent.

The napped leather-like sheet produced as described above comprises the leather-like sheet characterized in that, as mentioned above, the elastic fibers are partially porous, the elastic fibers are partially fuse-bonded to each other, the network structure is partially formed because of the partial fuse-bonding of the elastic fibers and the inelastic microfine fibers are partially fuse-bonded to the elastic fibers, and the napped surface formed at least one surface of the leather-like sheet which mainly comprises the inelastic microfine fibers. With such a structure, the napped leather-like sheet of the present invention exhibits an excellent elastic stretchability, feel and drapeability not found in known leather-like sheets, and are excellent in the surface touch, writing effect and appearance. The leather-like sheet of the present invention is further made into a grain-finished leather-like sheet by forming a coating layer on one of the surfaces thereof. The leather-like sheet of the present invention is applicable to wide variety of uses such as clothing, furniture, shoes and bags. The leather-like sheet of the present invention is particularly useful in the fields of high-class grain-finished products and high-class suede-finished products.

The present invention will be explained in more detail by reference to the following example which should not be construed to limit the scope of the present invention.

In the following examples, “part(s)” and “%” are based on mass unless otherwise noted. The measurement of the average single fiber fineness and the evaluations were made in the following methods.

(1) Average Single Fiber Fineness

The diameter of fibers were measured by observing the surface or cross section of leather-like sheet under an electron micrograph of 500 to 2000 magnifications. The average single fiber fineness (dtex) was determined from the measured values.

(2) Napping Appearance, Uniformity of Napping, Color Variation, Feel

Each evaluation was made by 10 manufacturers and distributors by visually or tactually observing the napped surfaces of the dyed napped leather-like sheets obtained in the following example and comparative examples. The results were expressed by A when the appearance, touch and feel were smooth like natural suede leather, B when slightly inferior to natural suede leather but with no practical problems, and C when inferior to natural suede leather and with little commercial value.

### EXAMPLE 1

Poly-3-methyl-1,5-pentane adipate glycol having an average molecular weight of 2000, 4,4′-diphenylmethane diisocyanate, polyethylene glycol and 1,4-butanediol were melt-polymerized so that the content of nitrogen attributable to the isocyanate group is 4.3% based on the total of the starting raw materials, thereby producing a polyester polyurethane having a melt viscosity of 5000 poise. In a screw extruder, 50 parts of the polyester polyurethane pellets after dried to a water content of 50 ppm or less (island elastic polymer) and 50 parts of low-density polyethylene pellets (sea component) were melt-kneaded and then melt-spun at 230° C. to obtain sea-island mix spun fibers (fibers Ao) having a fineness of 14 dtex in which a part of polyurethane exposed to the surface. Separately, 50 parts of nylon-6 pellets (island inelastic polymer) and 50 parts of polyethylene pellets (sea component) were melt-kneaded in a screw extruder and then melt-spun at 280° C. into sea-island mix spun fibers (fibers B₀) having a fineness of 10 dtex. The fibers A₀ and the fibers B₀ were mixed so that the mass ratio of the polyester polyurethane fibers and nylon fibers after the microfine fiber-forming treatment becomes 40:60, drawn 2.5 times, crimpled and cut to obtain staple fibers in a mixture of 7-dtex fibers of 51 mm long (fibers A₁) and 4-dtex fibers of 51 mm long (fibers B₁).

The mixed fibers were carded, made into a web by a crosslap webber, and needle-punched by single barb needles in a density of 1500 punches/cm² to obtain an entangled nonwoven fabric I having a mass per unit area of 800 g/m². The entangled nonwoven fabric I was shrunk in 95° C. hot water by 30% in area ratio to obtain an entangled nonwoven fabric II. Then, the entangled nonwoven fabric II was impregnated with an aqueous polyurethane emulsion containing a polyether polyurethane in a solid concentration of 2% (addition amount of polyurethane: 1% based on the entangled nonwoven fabric II), heat-treated, and then further heat-treated while drying in a dryer to allow the fibers to partially fuse-bonded to each other by softening the sea component polyethylene, thereby obtaining a well shape-sustaining entangled nonwoven fabric III having a thickness of 2.63 mm, a mass per unit area of 1040 g/m², and a density of 0.395 g/cm³.

The entangled nonwoven fabric III was impregnated with a 4% DMF solution of a polycarbonate polyurethane, immersed in a bath of a 30% aqueous solution of DMF at 40° C., and then washed with water to remove DMF remaining in the entangled nonwoven fabric III (treatment for making porous). Next, the entangled nonwoven fabric III was immersed in a hot toluene bath at 90° C. to remove the polyethylene in the fibers A₁ and the fibers B₁ by dissolution (treatment for forming microfine fibers) and dried to obtain a leather-like sheet I of about 1.3 mm thick.

The average single fiber fineness of the nylon microfine fibers in the leather-like sheet I was 0.01 dtex. As a result of observing the surface and the cross section of the leather-like sheet I under an electron microscope, it was found that the polyurethane fibers (elastic fibers) were partially porous, the polyurethane fibers were partially fuse-bonded to each other to form a partial network structure, and the polyurethane fibers were fuse-bonded to a part of the nylon microfine fibers (inelastic microfine fibers).

The leather-like sheet I was sliced into two parts along the major surface, and the sliced surface was polished by a buffing machine to obtain a leather-like sheet II of 0.50 mm thick. The surface opposed to the sliced surface of the leather-like sheet II was napped with a (#) 400 grit sandpaper to obtain a napped leather-like sheet, which was then dyed under the following conditions.

Dyeing Machine: Wince

Dyes:

Irgalan Brown 2RL (available from Ciba Specialty Chemicals K.K.) owf 4%

Irgalan Yellow 2GL (available from Ciba Specialty Chemicals K.K.) owf 1%

Dyeing Assistant:

Levelan NK-D (available from Marubishi Oil Chemical Co., Ltd.) 2 g/L Bath ratio: 1:20

Dyeing Time: 60 min at 90° C.

The napped leather-like sheet dyed in brown was crumpled and brushed with a brush roll to obtain a transversely stretchable, brown napped leather-like sheet excellent in the drapeability. The obtained napped leather-like sheet was excellent in the elastic stretchability and substantially sustained 10 times repetition of 30% extension without causing change of the original structure and configuration. The soft and dense feel and the excellent drapeability were also retained. The results of other evaluations are shown in Table 1.

### COMPARATIVE EXAMPLE 1

A leather-like sheet I of about 1.3 mm thick was produced in the same manner as in Example 1 except for omitting the treatment of the entangled nonwoven fabric III for making porous. The results of the observation on the surface and cross section of the leather-like sheet I under an electron micrograph showed that the elastic fibers were non-porous and not fuse-bonded to each other to fail in forming the network structure.

The leather-like sheet I was sliced into two parts along the major surface, and the sliced surface was polished by a buffing machine to obtain a leather-like sheet II of 0.52 mm thick. The surface opposed to the sliced surface of the leather-like sheet II was napped with a (#) 400 grit sandpaper to obtain a leather-like sheet. The obtained napped leather-like sheet was instable in the napping state and poor in the process passing properties. When dyed in brown under the same conditions as in Example 1, the napped leather-like sheet changed to a velour-like napped leather-like sheet which was lacking in napping feel, rough in appearance and uneven in napping. Although sufficient in the drapeability and stretchability, the dyed napped leather-like sheet changed its original structure and configuration after about 10 times repetition of 30% extension. Although the soft feel was retained, the dense feel was lost. The results of other evaluations are shown in Table 1.

### COMPARATIVE EXAMPLE 2

Raw fibers of only 4-dtex fibers B₀ were carded, made into a web by a crosslap webber, and needle-punched by single barb needles in a density of 1500 punches/cm² to obtain an entangled nonwoven fabric I having a mass per unit area of 800 g/m². The entangled nonwoven fabric I was heat-treated in a dryer to allow the fibers to partially fuse-bonded to each other by softening the sea component polyethylene, thereby obtaining an entangled nonwoven fabric III having a thickness of 2.65 mm, a mass per unit area of 850 g/m², and a density of 0.32 g/cm³. A 13% DMF solution of a polyether polyurethane was impregnated into the entangled nonwoven fabric III and coagulated in a 30% aqueous solution of DMF. After removing DMF by washing with water and drying, a leather-like sheet I comprising nylon 6 microfine fibers and foamed polyurethane sheets was obtained. The average single fiber fineness of the microfine fibers was 0.01 dtex. The surface and the cross section of the leather-like sheet I was observed under an electron microscope. The fibers had no porous structure and were not fuse-bonded together to fail in forming the network structure.

The leather-like sheet I was sliced into two parts along the major surface, and the sliced surface was polished by a buffing machine to obtain a leather-like sheet II of 0.50 mm thick. The surface opposed to the sliced surface of the leather-like sheet II was napped with a (#) 400 grit sandpaper to obtain a napped leather-like sheet, which was then dyed in brown under the same conditions as in Example 1. Although excellent in the appearance, the 5 obtained napped leather-like sheet was poor in the stretchability and changed its original structure and configuration after about 10 times repetition of 30% extension. The results of other evaluations are shown in Table 1.

TABLE 1

| | Thickness | Mass per unit area | Density |
|---|---|---|---|
| | (mm) | (g/m²) | (g/cm³) |
| Example | | | |
| 1 | 0.50 | 218 | 0.43 |
| Comparative | | | |
| Examples | | | |
| 1 | 0.52 | 218 | 0.42 |
| 2 | 0.50 | 190 | 0.38 |

| | | Uniformity | | |
|---|---|---|---|---|
| | Napping feel | of napping | Color variation | Feel |
| Example | | | | |
| 1 | A | A | A | A |
| Comparative | | | | |
| Examples | | | | |
| 1 | C | C | A | A |
| 2 | A | A | B | B |

What is claimed is:

1. A leather-like sheet comprising an entangled nonwoven fabric which is made of a mixture comprising fibers of an elastic polymer and microfine fibers of a inelastic polymer having an average single fiber fineness of 0.1 dtex or less, the fibers of the elastic polymer being partially porous and being partially fuse-bonded to each other.

2. The leather-like sheet according to claim 1, wherein the fibers of the elastic polymer are partially fuse-bonded to each other to form a partial network structure.

3. The leather-like sheet according to claim 1, wherein the fibers of the elastic polymer are partially fuse-bonded to a part of the fibers of the inelastic polymer.

4. The leather-like sheet according to claim 1 which is formed into a napped leather-like sheet by making at least one surface of the leather-like sheet into a napped surface mainly comprising napped inelastic microfine fibers.

5. A method of producing a leather-like sheet, sequentially comprising:
a step I of producing an entangled nonwoven fabric comprising the fibers A capable of forming fibers of an elastic polymer and the fibers B capable of forming microfine fibers of a inelastic polymer having an average single fiber fineness of 0.1 dtex or less, a component for forming the fibers of an elastic polymer being partially exposed at least to a part of surface of the fibers A;
a step II of impregnating a liquid containing at least a good solvent for the elastic polymer into the nonwoven fabric, thereby partially dissolving the elastic polymer;
a step III of impregnating a liquid containing at least a poor solvent for the elastic polymer into the nonwoven fabric, thereby making the partially dissolved elastic polymer into partially porous; and
a step IV of converting the fibers A and the fibers B respectively into the fibers of the elastic polymer and the microfine fibers of the inelastic polymer having an average single fiber fineness of 0.1 dtex or less.
